(19) United States
(12) Patent Application Publication
(10) Pub. No.: US 2002/0111215 A1
(43) Pub. Date: Aug. 15, 2002

(54) System and a method of providing entertainment over a computer network

(75) Inventor: Damon Kwok Wah Chan, New Territories (HK)

Correspondence Address: Richard P. Berg, Esq., c/o LADAS & PARRY, Suite 2100, 5670 Wilshire Boulevard, Los Angeles, CA, 90036-5679, US

(73) Assignee: WEI.COM.HK LIMITED

(21) Appl. No.: 10/075,772

(22) Filed: Feb. 13, 2002

(30) Foreign Application Priority Data
Feb. 14, 2001 (HK) 01101066.6

(51) Int. Cl. G06F 19/00; G06F 17/00; A63F 13/00; A63F 9/24

(52) U.S. Cl. 463/42

(57) ABSTRACT

There is disclosed a system and a method of providing entertainment over a computer network, including a server data processing system connected to a computer network, which server data processing system including a software configured and executable to allow games to be played by a user via a data processing apparatus connected to the server data processing system via said a computer network, e.g. the Internet, and the software is configured and executable to calculate and store number of points scored by the user during playing of said game(s) for which the user has not paid, to calculate and store the number of scored points for which the user has paid, and to allow the user to select at least a prize and to use the or part of the paid scored-points in exchange of the prize(s), and the software is configured and executable to allow the user to play said game(s) free of charge.

This invention relates to a method of providing entertainment over a computer network and, in particular, such a method whereby score points obtained during the course of the entertainment may be used in exchange for one or more prizes.

There are in existence entertainment establishments which allow customers to play games on site. Before playing-the games, the customer has to pay a sum of money in exchange for token coins, which are used for activating the game apparatus, or for allowing admission to playing certain games. A possible rate of exchange may be US$10 per 10 token coins. Some games may require one token coin, and some may require two token coins. Upon completion of the games, scores will be won, depending on the results of the game as played by the customer. Such scores may be represented by tickets. With a view to attracting customers, such entertainment establishments may also provide for the use of the tickets in exchange for prizes. Each item of prize is marked with a quantity of tickets, say 1,000 tickets for a watch, which with it may be redeemed. When the customer has accumulated up to, say, 1,000 tickets, he may approach the entertainment establishment, present the 1,000 tickets, and “redeem” the watch.

While various services (including the provision of entertainment) may now be provided over computer networks, e.g. the Internet. With particular reference to the provision of games over the computer networks, such are usually provided for money. The user will usually have to register as a member, provide credit card details to the service provider, and his account will be deducted according to the number of times and/or length of time of play, and/or result of the game played, right after the completion of the games. In most such arrangements, no tangible reward will be available to the user.

It is thus an object of the present invention to provide a system and a method of providing entertainment over a computer network in which the aforesaid shortcomings are mitigated, or at least to provide a useful alternative to the public.

According to a first aspect of the present invention, there is provided a system of providing entertainment over a computer network, comprising a server data processing system connected to a computer network, which server data processing system including a software configured and executable to allow at least a game to be played by a user via a data processing apparatus connected to said server data processing system via said computer network, wherein said software is configured and executable to calculate and store number of points scored by said user during playing of said game(s) for which the user has not paid, to calculate and store number of scored points for which the user has paid, and to allow said user to select at least a prize and to use said or part of said paid scored-points in exchange of said prize(s), characterized in that said software is configured and executable to allow said user to play said game(s) free of charge.

According to a second aspect of the present invention, there is provided a method of providing entertainment over a computer network, including the steps of (a) providing a server data processing system connected to a computer network, which server data processing system including a software; (b) providing at least a game playable by a user via a data processing apparatus connected to said server data processing system via said computer network; (c) calculating and storing number of points scored by said user during playing of said game(s) for which said user has not paid; (d) calculating and storing number of scored points for which said user has paid; (e) assigning a respective amount of points to each of a plurality of prizes; characterized in including a step of configuring said software to enable said user to play said game(s) free of charge.

An embodiment of the present invention will now be described, by way of an example only, and with reference to the accompanying

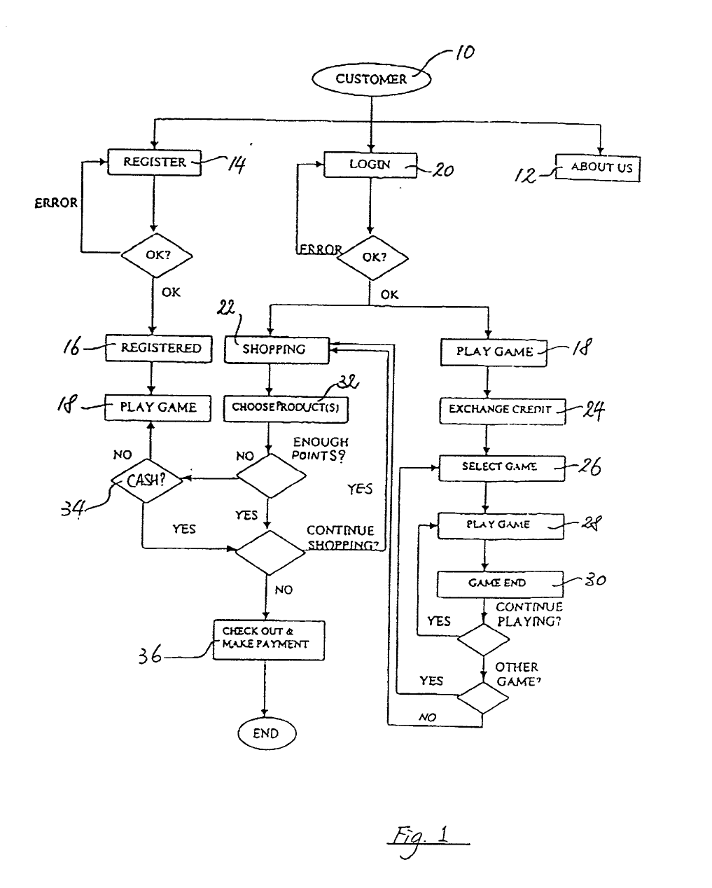

FIG. 1, which is a flow chart showing the steps of operation of a method and a system according to the present invention.

An establishment working a method and a system according to the present invention may set up a web site on the Internet, which is accessible by customers who have access to computers, which are also connectable to the Internet. A general layout of the web site may contain:

a. a “Main Page” section as the entry point;

b. an “About Us” section providing information about the establishment providing the entertainment by way of the present invention, the web site and/or the services and entertainment provided therein;

c. a “Shopping/Catalogue” section including:

i. an “Online Catalogue” sub-section providing information of prizes/products which the customers can use their points to buy/redeem. Such information may include photographs of the products, number of points required for redemption, unit price, and a brief description of the products. This section may further include two sub-sections, namely a “Bargain Centre” giving details of “discounted” prizes/products, and a “New Products” sub-section giving details of newly launched prizes/products;

ii. e-commerce facilities, e.g. shopping cart, online credit card payment, which allow the customer to designate the product(s) which he wishes to redeem, and, if necessary, to debit his account with the credit card company;

iii. a “Check Out” page; and

iv. a “Confirmation” section;

d. a “User Registration” section allowing user to register with the establishment, by providing the establishment with his details, e.g. name, e-mail address, address, credit card number, etc. The customer will also receive his user identity number and password allowing him to enter the “Game” section (to be discussed below) to play one or more games. Such details will also allow the establishment to identify the specific users and to prevent unauthorized entry of unregistered users to the “Game” section. Such details will be stored in a User Database containing such information, which will also keep track of the respective customer's accounts status (e.g. number of credits (to be discussed below) borrowed or earned, and points scored). By inputting his user identity number and password, the customer may also keep track of total points scored by him so far, and status of the credits (to be discussed below) borrowed and/or paid so far;

e. a “Game” section containing a number of games, e.g. Mahjong or Backgammon, which may be played by a customer over his own computer, which is connected via the Internet with the web site of the establishment. Each game has its own web page; and

f. an “Enquiry Form” section operable on e-mail format which allows users to make inquiries with the establishment.

The web site of the establishment is operated by a main server computer connected to the Internet, which main server computer being provided with a software for operating the present invention. The main server computer is also connected with the credit card company so as to enable the customers' credit card accounts to be debited, as and when necessary. In addition, the following databases are also kept and maintained by the main server computer:

a. hits tracking system, keeping track of the number of visitors to the web site;

b. e-mail address, identity number and password for members;

c. accounts status of each member, keeping track of the number of credits “borrowed”, the number of packets of points scored, and the number of points in each packet(differentiating between paid points and unpaid points); and

d. prizes redeemed or purchased by each member.

FIG. 1 shows a flow chart of the steps of operation of a method and a system according to the present invention. A customer 10 may enter the web site of the establishment working the method and system according to the present invention via his personal computer, which is connected with the web site of the establishment via the Internet. Once the customer is successfully connected with the web site of the establishment, the “Main Page” will be shown on his computer. Apart from some promotional and/or introductory materials, the customer will be provided with the option of entering at least three sub-sections, namely “ABOUT US”, “REGISTER” and “LOGIN”.

The customer may enter into the “ABOUT US” sub-section (Step 12) and look up details about the establishment, the web site, and the entertainment and/or services provided therein.

The customer may be a first time visitor of the site, and wishes to register as a member. He may then enter the “REGISTER” sub-section (Step 14). Upon prompting of the web site of the establishment, the customer will be required to enter various details, e.g. his e-mail address, address, credit card account number, etc., which allow the establishment to contact him, to provide him with news and development regarding the web site, and to debit his credit card account as necessary. If the whole registration process is successful, the customer will then be registered (Step 16), and become a member of the establishment. A user identity number and a password will be provided to him allowing him to play the games provided by the web site.

A customer may start playing games (Step 18) right after his being registered as a member (Step 16). As for an existing member, upon connection of his computer with the web site of the establishment, he may login (Step 20) by providing his user identity number and password. If the login (Step 20) is successful, he may choose to play game (Step 18). Alternatively, he may also go shopping (Step 22), i.e. redeem one or more products with his scores.

If the customer starts playing games (Step 18), he can “borrow” or “exchange” a batch of, say, 50, credits (Step 24) for playing the games. He may then-select the game (Step 26) he wants to play, read the Rules and Regulations of the games, and start playing (Step 28). A pre-determined number of credits assigned for each respective game will be deducted from the total remaining credits of the user, upon playing of the game. Upon completion of the game (Step 30), he may decide to continue playing, whereupon he will be directed back to the same game, be deducted the corresponding number of credits, so that he may play the same game again (Step 28). Alternatively, he may decide to play another game, whereupon he will be directed back to select a game (Step 26), be deducted the corresponding number of credits corresponding to this game, and plays the game (Step 28). If, and only if, he has spent all the borrowed credits may he borrow/exchange more credits (Step 24).

During the playing of the game(s), points will be scored depending on the performance of the customer during the games. All points scored by using the same batch of credits will be summed up and collected as a single “packet” of points. For example, if the customer borrows a first batch of 50 credits and scores 5,000 points, and subsequently borrows a second batch of 50 credits and scores 7,000 points, two packets of points, one of 5,000 points, and one of 7,000 points, will be created and stored in the main server computer under the accounts of this customer. These packets will also be “sealed”, meaning that the number of points in each packet cannot be increased or decreased. These points are called “Unpaid points”, as the customer has not paid anything for these points. Additional credits can be borrowed or exchanged only when all existing credits are used up.

A total of thirty packets of unpaid points can be stored and kept track of by the main server computer. If a thirty-first packet of unpaid points is created, the packet with the lowest number of points will be removed from the system, thus maintaining a total number of thirty packets.

When the customer decides not to play on, he may simply decide to quit the web site, while still leaving the total of credits borrowed, and points scored intact. Such results may be used in any subsequent games. It can be seen that, by way of such an arrangement, the player is not obliged to pay in order to start playing games, in fact even after playing. He can have as many free trial plays as he desires, He may even delete all existing results (including both the credits borrowed and the points scored), so that he may start afresh next time.

On the other hand, the customer may decide to see if there is any prize he wishes to redeem with his scored points. He may then go shopping (Step 22). The Online Catalogue page will then be shown, whereby details of various prizes/products (which may be such products as watches or cameras) are shown. The customer may then choose the product(s) (Step 32) which he wishes to obtain. If he has enough unpaid points, he may “redeem” the product by “settling” the required number of packets of unpaid points, whereby a corresponding number of borrowed credits will be marked as paid, and the corresponding amount of money debited from his credit card account. The-settling rate for the unpaid points may be, say, US$50 for each batch of 50 credits. Thus, each packet of points may be redeemed at US$50. Under this system, points can only be settled in whole number of packets, but not a portion thereof

For example, assuming that the customer borrows three batches of credits, each of 50, and, after playing the game(s), obtained a first packet of 5,000 unpaid points, a second packet of 7,000 unpaid points, and a third packet of 8,000 unpaid points, and he wants to redeem a cassette tape recorder, with a “point” prize of 11,000, he may of course settle any of the two packets, at a total cost of US$100. However, it would be wise of him to settle the second and third packets, thus converting such into 15,000 paid points, as the average cost of the paid points would be 15,000 points per US$100, i.e. 150 points per US$1. Whereas if the customer settle the first and packets, the average cost of the paid points would be 120 points per US$1. On the other hand, the Examiner cannot settle the third packet and only 3,000 of the second packet, as points can only be settled in packets.

Assuming that the customer redeems the second and third packets, US$200 will be debited from his credit card account and 15,000 points will be marked as paid. These paid points may then be used for redeeming products. Assuming that he uses 11,000 points to redeem a cassette tape recorder, 4,000 paid points will left in his account, which may be used for redeeming further products.

If there are not sufficient unpaid points, or if the customer is not satisfied with the number of points in the packets, the customer may decide to pay for the full amount of the product in cash (Step 34), i.e. by allowing his credit card account to be directly debited. In this connection, each item of redeemable product has both a point price and a cash price. Alternatively, the customer may decide to play more game(s) in the hope of accumulating the necessary number of scored points.

In any event, after the customer has completed all his shopping, and after the shopping details are confirmed, the customer will check out and make payment (Step 36), whereby a corresponding amount of money will be debited from the customer's credit card account.

As an example, let us assume that an existing customer, with an accumulated records of no borrowed credits and 2,000 paid points, enters the web site. He chooses to play Backgammon. He borrows a first batch of 50 credits. Assuming that each game of Backgammon requires 10 credits, and he plays a total of five games, thus fully using all 50 credits, and scores a total of 5,000 points. According to the databases kept by the main server computer, this customer now has a total of 50 borrowed credits, and 2,000 paid points, and a packet of 5,000 unpaid points. Assuming now that the client wishes to check if he can redeem certain prizes with his 7,000 points. He then enters the “Shopping/Catalogue” page and finds that a digital watch is indicated as redeemable at 6,000 points. He then chooses this digital watch and makes all the necessary confirmations. In particular, his credit card account will be debited of the amount for the 50 credits borrowed, e.g. US$100. When he checks out, he will have 1,000 paid points left, and his credit card account will be debited by US$100.

The player may score exceptionally high points when playing a certain game. He may then decide to pay for the credits for scoring these points, so that he may use these paid points in future redemption of products, as the average cost for these points is relatively low.

Upon completion of the above procedure, further activities will be carried out in conjunction with the main server computer. Upon debiting of the customer's credit card account and receipt of the relevant details regarding the items of product(s) redeemed, the software of the main server computer will retrieve from the relevant database details regarding the customer, e.g. his address. All such information will then be incorporated into a product delivery memo to be received by the goods delivery department, which will then arrange for the prize (which in the above example is the digital watch) to be delivered to the customer at his address.

For working this invention, the following computer hardware and software may be employed:

a. Hardware

one Sun Microsystems Enterprise 420R, of Sun Microsystems Inc.—Dual 450 MHz CPU, 1GB RAM, 18 GB Hard Disk, 72 GB Hard-Disk External

one Sun Microsystems Enterprise 220R, of Sun Microsystems Inc.—Dual 450 MHz CPU, 512 MB RAM, 18 GB Hard-Disk

one Sun Microsystems Enterprise 220R, of Sun Microsystems Inc.—450 MHz CPU, 256 MB RAM, 18 GB Hard-Disk, 72 GB Hard-Disk External

one Sun Microsystems Enterprise 220R, of Sun Microsystems Inc.—450 MHz CPU, 256 MB RAM, 9 GB Hard-Disk

b. Software

Sun Solaris 7 Operating System, of Sun Microsystems Inc.

Apache 1.3 Web Server, of Apache Software Foundation

Microsoft Windows NT 4.0, of Microsoft Inc.

Microsoft Windows 98 Second Edition, of Microsoft Inc.

Microsoft Office 97, of Microsoft Inc.

Allaire ColfFusion 4.5.1 Server, of Allaire Corporation

Allaire ColdFusion 4.5.1 Studio, of Allaire Corporation

Oracle 8.1.6 Standard Edition, of Oracle Inc.

Macromedia Flash 4, of Macromedia Inc.

Macromedia Dreamweaver 3, of Macromedia Inc.

Adobe Photoshop 5.5 of Adobe Systems Inc.

3D Studio MAX 3.0 of Auodesk Inc.

It should be understood that the above only describes an embodiment whereby the above invention may be carried out, and that various modifications and alterations may be made thereto. Additional features may also be incorporated. As an example, the web site may allow spaces for advertising by other companies or businesses. In addition, even if the customer may not wish to play any games, he may still enter the “Shopping/Catalogue” page, chooses the product he wants, and pay by directly debiting his credit card account.

1. A system of providing entertainment over a computer network, comprising a server data processing system connected to a computer network, which server data processing system including a software configured and executable to allow at least a game to be played by a user via a data processing apparatus connected to said server data processing system via said computer network, wherein said software is configured and executable to calculate and store number of points scored by said user during playing of said game(s) for which the user has not paid, to calculate and store number of scored points for which the user has paid, and to allow said user to select at least a prize and to use said or part of said paid scored-points in exchange of said prize(s), characterized in that said software is configured and executable to allow said user to play said game(s) free of charge.

2. A system according to claim 1 further characterized in that said software is configured and executable to calculate and store number of unpaid points scored by said user in packets each corresponding to a pre-determined number of credits borrowed.

3. A system according to claim 2 further characterized in that said software is configured and executable to store a maximum of thirty packets of unpaid scored points.

4. A system according to claim 2 further characterized in that said software is configured and executable to require a respective pre-determined number of credits for playing each or the game.

5. A system according to claim 2 further characterized in that said software is configured and executable to allow said user to remove at least one packet of scored unpaid points.

6. A system according to claim 4 further characterized in that said software is configured and executable to allow said user to remove at least one packet of scored unpaid points.

7. A system according to claim 2 further characterized in that said server data processing system is connected to at least one financial institution and said software is configured and executable to debit said user's account with said financial institution only when said points scored during playing of said game(s) are used in exchange for said prize(s).

8. A system according to claim 6 further characterized in that said server data processing system is connected to at least one financial institution and said software is configured and executable to debit said user's account with said financial institution only when said points scored during playing of said game(s) are used in exchange for said prize(s).

9. A system according to claim 6 further characterized in that said software is configured and executable to store data relating to said user.

10. A system according to claim 7 further characterized in that said software is configured and executable to store data relating to said user.

11. A system according to claim 8 further characterized in that said software is configured and executable to store data relating to said user.

12. A system according to claim 2 wherein said computer network is Internet.

13. A system according to claim 8 wherein said computer network is Internet.

14. A system according to claim 11 wherein said computer network is Internet.

15. A method of providing entertainment over a computer network, including the steps of:
(a) providing a server data processing system connected to a computer network, which server data processing system including a software;
(b) providing at least a game playable by a user via a data processing apparatus connected to said server data processing system via said computer network;
(c) calculating and storing number of points scored by said user during playing of said game(s) for which said user has not paid;
(d) calculating and storing number of scored points for which user has paid;
(e) assigning a respective amount of points to each of plurality of prizes; characterized in including a step of configuring said software to enable said user to play said game(s) free of charge.

16. A method according to claim 15 further characterized in including a step of assigning a pre-determined number of credits to said user.

17. A system according to claim 16 further characterized in including a step of deducting a respective pre-determined number of credits from the credits assigned to said user for playing each or the game.

18. A system according to claim 17 further characterized in that at least a portion of the existing total of unpaid points is removable by said user.

19. A system according to claim 17 further characterized in that said server data processing system is connected to at least one financial institution and said software is configured and executable to debit said user's account with said financial institution only when said points scored during playing of said game(s) are used in exchange for said prize(s).

20. A system according to claim 18 further characterized in that said server data processing system is connected to at least on financial institution and said software is configured and executable to debit said user's account with said financial institution only when said points scored during playing of said game(s) are used in exchange for said prize(s).
